(19) United States
(12) Patent Application Publication
(10) Pub. No.: US 2007/0140274 A1
(43) Pub. Date: Jun. 21, 2007

(54) Centralised irrigation automation system for a building provided with local computer network with standard network protocol

(76) Inventors: Roberto Battistutto, Udine (IT); Andrea Brundisini, Bologna (IT); Stefano Del Cont Bernard, Aviano (PN) (IT); Franco Milan, Caneva (PN) (IT)

Correspondence Address: JACOBSON HOLMAN PLLC, 400 SEVENTH STREET N.W., SUITE 600, WASHINGTON, DC, 20004, US

(21) Appl. No.: 11/639,192

(22) Filed: Dec. 15, 2006

(30) Foreign Application Priority Data
Dec. 15, 2005 (IT) MI2005A 002388

(51) Int. Cl. H04L 12/56; A01G 27/00

(52) U.S. Cl. 370/401; 239/69

(57) ABSTRACT

A centralised automation system for an irrigation system is disclosed that is associable with a local computer network of standard type with a standard network protocol of a building in a so-called “building automation” context. The automation system comprises a field control unit (4) for receiving, storing and issuing irrigation commands according to preset programs. The field control unit (4) is inserted into the building and interfaced with the local computer network (3) of the building in such a way as to communicate therewith by means of a dedicated protocol (EPRAS) based on a standard network protocol (TCP/IP). For each irrigable field sector there is provided a respective field bus (6) that acts as a transmission support with standard field protocol (ModBus) for communicating irrigation commands to a respective control unit (7) for solenoid valves (9). A respective protocol-translation bridge unit (12) enables the field bus (6) to be interfaced with the local computer network (3) (FIG. 1).

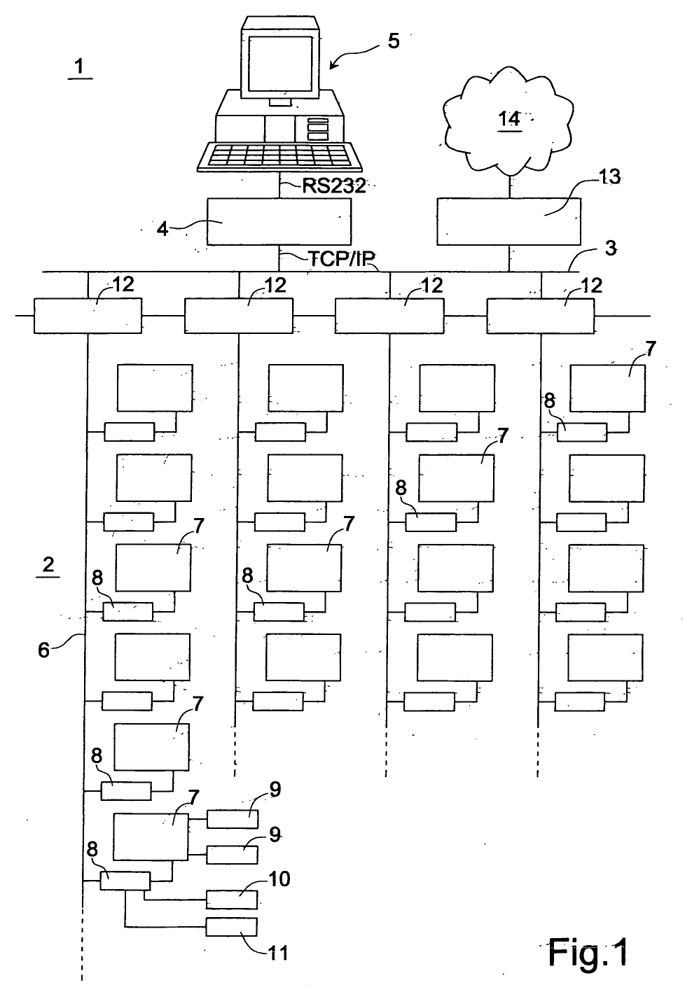

The present invention relates to a centralised irrigation automation system for irrigable fields, such as for example gardens, parks, etc, which is associable with a pre-existing building automation system in a so-called “building automation” context.

Normally, irrigation automation systems for irrigable spaces of buildings of various types (hotels, shopping malls, company headquarters, etc) operate on transmission supports (standard electric networks) and with proprietary data-exchange protocols (network dialogue modes), i.e. provided expressly and independently for other systems.

The object of the present invention is to provide a centralised automation system for irrigation systems of buildings provided with a local computer network with a standard network protocol, that is able to operate on the same transmission supports and with the same standard protocols with which the building is already provided, thus being able to live and operate together with other automation systems that are part of the life of the building and are in perfect harmony therewith.

According to the invention, this object is achieved with a centralised irrigation automation system that is characterised in that it comprises a field control unit for receiving, storing and issuing irrigation commands according to preset programs that is inserted into the building and interfaced with the local computer network of the building in such a way as to communicate therewith by means of a dedicated protocol based on a standard network protocol and, for each irrigable field sector, a respective field bus that acts as a transmission support with standard field protocol for communicating said irrigation commands to a respective control unit for solenoid valves and a respective protocol translation bridge unit for interfacing said field bus with said local computer network.

In this way, the irrigation automation system according to the present invention can use transmission supports and operate with standard protocols that are already present in the building, operating together with the same language and in harmony with other pre-existing automation systems.

If, as is usual, the local network (LAN) of the building is Ethernet with TCO/IP protocol (Transmission Control Protocol/Internet Protocol), the automation system can also be seen and managed through Internet by using a standard browser.

The features of the present invention will become clearer from the following detailed description of a practical embodiment thereof illustrated by way of non-limiting example in the enclosed drawing.

The drawing shows schematically a centralised irrigation automation system for a building (indicated by 1) that has an irrigable field (indicated by 2) with several sectors and is provided with a local computer network Ethernet 3 with a standard TCP/IP network protocol.

Within the building there is provided a field control unit 4 that is capable of receiving, storing and issuing irrigation commands.

In particular, the field control unit 4 is programmed by means of a PC (Personal Computer) 5 provided with suitable software. The PC 5 constitutes the interface point with the operator and there are constructed thereupon all the real-time management rules of the irrigation system (description of the hydraulic and electric networks, irrigation programs, management methods of the sensors and field alarms, hydraulic and horticultural field parameters) and the reports returned from the field are read (irrigating activities report, alarms list, water consumption). Furthermore, the PC 5 performs manual and diagnostic tasks on the system. The PC 5 is connected to the field control unit 4 by means of an RS232 serial line, so it is not connected to the network but is connected point-to-point in a dedicated manner.

The field control unit 4 is an autonomous unit, i.e. it is able to manage the irrigation activity of the field 2 even after the PC has been switched off, with which it furthermore communicates periodically at the request of the user. From the PC 5 it receives all the management rules and returns the aforesaid reports thereto. The field control unit 4 interfaces with the local computer network 3 of the building and dialogues by means of a dedicated proprietary protocol (here called EPRAS) based on the same standard TCP/IP as the network 3. The field control unit 4 occupies a static IP address of the local network 3.

For each sector of the irrigable field 2 there is provided as a data transmission support a respective field bus 6 of RS485 serial type that operates with a standard field protocol (for example of the ModBus type) to send the irrigation commands issued by the field control unit 4 to a control unit 7 by means of an adaptor 8. The control unit 7 controls a plurality of solenoid valves 9 of the irrigation system. The adaptor 8 acts as an interface between the bus 6 and the control unit 7 by decoding the ModBus commands and transforming them into electric actions performed by the control unit 7 on the electric valves 9 to switch the aforesaid solenoid valves on and off. The adaptor 8 is also able to read a water counter 10 (for example of volumetric type) and communicate consumption data to the field control unit 4, as well as to record and transmit the data of appropriate sensors 11. For the sake of simplicity in the drawing, the solenoid valves 9, the counter 10 and the sensors 11 are shown only in relation to one of the adaptor-control units illustrated in the drawing.

Each field bus 6 is interfaced with the local network 3 by means of a bridge unit 12 that acts as a TCP/IP—ModBus protocol translator and vice versa to enable the field control unit 4 to send commands to the control units 7 and receive the corresponding replies, including the chronological indication of the activities, consumption and any alarms. Each bridge unit 12 occupies a static IP address of the local network 3.

Lastly, a router 13 may be provided for an Internet connection (represented schematically and indicated by 14) of the field control unit 4, which may constitute a small Web server.

1. A centralised irrigation automation system for an irrigable field of a building provided with a computer network with standard network protocol, characterised in that it comprises a field control unit for receiving, storing and issuing irrigation commands according to preset programs that is inserted into the building and interfaced with the local computer network of the building in such a way as to communicate therewith by means of a dedicated protocol (EPRAS) based on a standard network protocol (TCP/IP) and, for each irrigable field sector, a respective field bus that acts as a transmission support with standard field protocol (ModBus) for communicating said irrigation commands to a respective control unit for solenoid valves and a respective protocol translation bridge unit for interfacing said field bus with said local computer network.

2. The centralised system according to claim 1, characterised in that it comprises an adaptor interposed between said field bus and said control unit for decoding said irrigation commands transmitted with a standard field protocol (ModBus) and transforming them into electric actions for the control unit.

3. The centralised system according to claim 2, characterised in that said adaptor is able to read a water counter and transmit the corresponding readings to said field control unit by means of said field bus and said bridge unit.

4. The centralised system according to claim 2, characterised in that said adaptor is able to receive the sensor data and transmit them to said field control unit by means of said field bus and said bridge unit.

5. The centralised system according to claim 1, characterised in that said field control unit is connected through a serial line to a PC intended for the construction of irrigation management rules and sending them to said field control unit.

6. The centralised system according to claim 1, characterised in that it comprises a router for connecting said field control unit to Internet by means of said local network.
